(19) United States
(12) Patent Application Publication
(10) Pub. No.: US 2025/0304452 A1
(43) Pub. Date: Oct. 2, 2025

(54) STABILIZED AQUEOUS ACTIVE SILICA SOLUTION, SILICA SOL USING SAME, AND METHOD FOR PRODUCING SAME

(71) Applicant: NISSAN CHEMICAL CORPORATION, Tokyo (JP)

(72) Inventors: Shigeru MITSUI, Funabashi-shi (JP); Tohru NISHIMURA, Funabashi-shi (JP)

(73) Assignee: NISSAN CHEMICAL CORPORATION, Tokyo (JP)

(21) Appl. No.: 18/285,022

(22) PCT Filed: Mar. 23, 2022
(86) PCT No.: PCT/JP2022/013669

§ 371 Date: Mar. 8, 2024

(30) Foreign Application Priority Data
Mar. 31, 2021 (JP) 2021-061377

(51) Int. Cl. C01B 33/148

(52) U.S. Cl. CPC C01B 33/1485

(57) ABSTRACT

A stabilized aqueous active silica solution including at least one stabilizing agent selected from an acid, potassium hydroxide, ammonia and an organic base, whose content is 0.167 to 10% by mass/SiO2 relative to solution. The acid is an inorganic or organic acid. The inorganic acid is sulfuric or nitric acid. The organic acid is citric acid. The base is an amine or quaternary ammonium hydroxide. The viscosity of the solution that has a SiO2 concentration of 2.8 to 3.3% by mass, measured by the Ostwald method at 23° C. within 3 hours after production, is 0.5 to 20 mPa·s. The viscosity of the solution measured after storage at 23° C. for 3 days is higher by 5.0 times or less than that of the solution measured within 3 hours. Also, a silica sol including silica particles having an average primary particle diameter of 5 to 300 nm.

### TECHNICAL FIELD

The present invention relates to a stable high-purity aqueous active silica solution, a silica sol produced by using the solution, and a production method for the silica sol.

### BACKGROUND ART

A silica sol wherein silica particles are highly dispersed in an aqueous medium is produced by a silica sol production method involving preparing an aqueous active silica solution by removal of cations from liquid glass, and polymerizing the active silica in the aqueous solution, thereby forming silica particles in the aqueous medium.

For example, there has been disclosed a production method for a silica sol containing dispersed silica particles having an average particle diameter of 10 to 30 nm, wherein an aqueous alkali silicate solution is treated with a cation-exchange resin to thereby prepare a cation-removed aqueous active silica solution; a strong acid (e.g., nitric acid) is added to the aqueous active silica solution, and then the resultant mixture is brought into contact with a cation-exchange resin and an anion-exchange resin, to thereby prepare an aqueous active silica solution; and an alkali metal hydroxide is added to the aqueous active silica solution, and the resultant mixture is maintained at 60 to 150° C. with stirring (see Patent Documents 1 and 2).

There has also been disclosed a silica sol production method wherein an aqueous alkali silicate solution is treated with a cation-exchange resin to thereby prepare a cation-removed aqueous active silica solution; a strong acid (e.g., nitric acid or hydrochloric acid) is added to the aqueous active silica solution, and then the resultant mixture is brought into contact with a cation-exchange resin and an anion-exchange resin, to thereby prepare an aqueous active silica solution; and an aqueous ammonia solution is added to the aqueous active silica solution, followed by aging (see Patent Document 3).

### PRIOR ART DOCUMENTS

Patent Documents

Patent Document 1: JP 1988-285112 A

Patent Document 2: JP 1993-097422 A

Patent Document 3: JP 1988-021212 A

### SUMMARY OF THE INVENTION

### Problems to be Solved by the Invention

However, the aqueous active silica solution is unstable, and active silica undergoes polycondensation in the aqueous solution. Thus, the methods described in Patent Documents 1 to 3 pose a problem that difficulty is encountered in controlling the particle diameter distribution and particle shape of silica particles. Therefore, a demand has arisen for development of a silica sol containing dispersed silica particles having controlled particle diameter distribution and particle shape.

The present invention provides a stabilized aqueous active silica solution prepared by stabilization of an unstable aqueous active silica solution. The present invention also provides a silica sol produced by using the stabilized aqueous active silica solution and containing dispersed silica particles having controlled particle diameter distribution and particle shape, and a production method for the silica sol.

### Means for Solving the Problems

A first aspect of the present invention is a stabilized aqueous active silica solution comprising at least one stabilizer A selected from the group consisting of an acid, potassium hydroxide, ammonia, and an organic base, wherein the amount of the stabilizer A is 0.167 to 10% by mass relative to the mass of SiO₂ contained in the aqueous active silica solution.

A second aspect of the present invention is the stabilized aqueous active silica solution according to the first aspect, wherein the acid is an inorganic acid or an organic acid.

A third aspect of the present invention is the stabilized aqueous active silica solution according to the second aspect, wherein the inorganic acid is sulfuric acid or nitric acid.

A fourth aspect of the present invention is the stabilized aqueous active silica solution according to the second aspect, wherein the organic acid is citric acid.

A fifth aspect of the present invention is the stabilized aqueous active silica solution according to the first aspect, wherein the organic base is an amine or a quaternary ammonium hydroxide.

A sixth aspect of the present invention is the stabilized aqueous active silica solution according to any one of the first to fifth aspects, wherein the aqueous active silica solution having an SiO₂ concentration of 2.8 to 3.3% by mass exhibits a viscosity of 0.5 to 20 mPa·s as measured by the Ostwald method at 23° C. within three hours after production, and the viscosity of the aqueous active silica solution measured after storage at 23° C. for three days is 5.0 times or less the viscosity measured at 23° C. within three hours after production.

A seventh aspect of the present invention is a silica sol comprising silica particles that are a polycondensate of the active silica contained in the stabilized aqueous active silica solution according to any one of the first to sixth aspects, wherein the silica particles have an average primary particle diameter of 5 to 300 nm.

An eighth aspect of the present invention is the silica sol according to the seventh aspect, wherein the silica sol contains potassium ions and sodium ions, and, when the silica sol has an SiO₂ concentration of 20% by mass, the amount of potassium ions contained in the silica sol is 1,500 to 5,000 ppm, and the ratio of (potassium ion concentration by ppm)/(Na ion concentration by ppm) is 100 to 1,000.

A ninth aspect of the present invention is a production method for the silica sol according to the seventh or eighth aspect, the production method comprising the following processes (a) and (b):
process (a): a process including a step of incorporating, into an aqueous active silica solution (a0), at least one stabilizer A selected from the group consisting of an acid, potassium hydroxide, ammonia, and an organic base so that the amount of the stabilizer A is 0.167 to 10% by mass/SiO₂, thereby preparing a stabilized aqueous active silica solution (a1), and a step of incorporating potassium hydroxide into the stabilized aqueous active silica solution (a1) or a silica sol containing silica particles having an average primary particle diameter of 5 to 90 nm so that the ratio by mole of SiO₂/K₂O is 1.5 to 20, thereby preparing the seed liquid (a2); and
process (b): a process of heating the seed liquid (a2) prepared in the process (a) at 90 to 150° C.

A tenth aspect of the present invention is the production method for the silica sol according to the ninth aspect, wherein the aqueous active silica solution (a0) used in the process (a) is prepared through a process (c1) of preparing an aqueous active silica solution by cation exchange of liquid glass, a process (c2) of adding an acid to the aqueous active silica solution, and aging the aqueous active silica solution at a temperature of higher than 0° C. and lower than 40° C. for 1 to 30 hours, and a process (c3) of subjecting the aged aqueous active silica solution to cation exchange and anion exchange, thereby preparing the aqueous active silica solution (a0).

An eleventh aspect of the present invention is the production method for the silica sol according to the ninth aspect, wherein, in the process (c2), the aqueous active silica solution exhibits a pH of 0.5 to 3.0 after addition of the acid, and the aqueous active silica solution (a0) prepared through the process (c3) exhibits a pH of more than 3.0 and 6.0 or less.

A twelfth aspect of the present invention is the production method for the silica sol according to the tenth or eleventh aspect, wherein the acid used in the process (c2) is sulfuric acid.

A thirteenth aspect of the present invention is the production method for the silica sol according to any one of the ninth to twelfth aspects, wherein the process (b) further includes a process of adding, to the heated seed liquid (a2), a feed liquid (b1) stabilized by adding at least one stabilizer B selected from the group consisting of an acid, potassium hydroxide, ammonia, and an organic base to the aqueous active silica solution (a0) so that the amount of the stabilizer B is 0.167 to 10% by mass relative to the mass of SiO₂ contained in the aqueous active silica solution.

A fourteenth aspect of the present invention is the production method according to the thirteenth aspect, wherein the stabilizer A is sulfuric acid, the agent for adjusting the ratio by mole of SiO₂/K₂O is potassium hydroxide, and the stabilizer B is sulfuric acid.

A fifteenth aspect of the present invention is the production method according to the thirteenth aspect, wherein the stabilizer A is potassium hydroxide, the agent for adjusting the ratio by mole of SiO₂/K₂O is potassium hydroxide, and the stabilizer B is potassium hydroxide.

### Effects of the Invention

An aqueous active silica solution is prepared by removing alkali ions from an aqueous alkali silicate solution with, for example, a cation-exchange resin.

The active silica contained in the aqueous active silica solution grows into silica particles through polycondensation, and a dispersion of the silica particles becomes a silica sol. However, the aqueous active silica solution is a very unstable substance, and thus the active silica (e.g., orthosilicate monomer or pyrosilicate dimer) contained in the aqueous active silica solution gradually undergoes polycondensation even at ambient temperature and is formed into silica particles of high molecular weight. The variation in the molecular weight of the silicate component in the aqueous active silica solution causes difficulty in controlling the particle diameter distribution and particle shape of silica particles grown from the silicate component, resulting in difficulty in achieving the reproducibility of the particle diameter distribution and the particle shape.

The present inventors have found that stable active silica can be produced by adding a predetermined amount of a stabilizer (e.g., an acid, potassium hydroxide, ammonia, or an organic base) to an aqueous active silica solution. When an alkali component is added to the stable aqueous active silica solution, and particles are grown therefrom, the particle diameter distribution and particle shape of the resultant silica particles can be controlled.

The aqueous active silica solution prepared from an aqueous alkali silicate solution contains metal impurities contained in the raw material. In order to remove the metal impurities, a strong acid (e.g., sulfuric acid) is added to the resultant aqueous active silica solution, to thereby convert the metal impurities into impurity ions with the acid for leaching (elution) of the impurity ions. The eluted impurity ions can be removed through cation exchange and anion exchange of the aqueous active silica solution, to thereby produce an aqueous active silica solution with higher purity. In the present invention, such a high-purity aqueous active silica solution can be provided with stability by incorporating a specific amount of a stabilizer into the aqueous active silica solution. In the present invention, silica particles are grown through polycondensation of the silicate component contained in the stable high-purity aqueous active silica solution, and thus the resultant silica sol contains dispersed silica particles having controlled particle diameter distribution and particle shape.

### MODES FOR CARRYING OUT THE INVENTION

The present invention is directed to a stabilized aqueous active silica solution containing at least one stabilizer A selected from the group consisting of an acid, potassium hydroxide, ammonia, and an organic base in an amount of 0.167 to 10% by mass/SiO₂. The aforementioned SiO₂ corresponds to SiO₂ contained in the stabilized aqueous active silica solution. Thus, the aqueous active silica solution of the present invention contains the stabilizer A in an amount of 0.167 to 10% by mass relative to the mass of SiO₂ contained in the stabilized aqueous active silica solution. The SiO₂ concentration is 1 to 10% by mass in the stabilized aqueous active silica solution.

The aqueous active silica solution used as a raw material in the present invention is prepared by dealkalization of an aqueous alkali silicate solution. The alkali silicate is, for example, sodium silicate or potassium silicate, and is preferably sodium silicate. No particular limitation is imposed on the aqueous alkali silicate solution used, and, for example, an aqueous sodium silicate solution (which is also called liquid glass) exhibiting a ratio by mole of SiO₂/Na₂O of 0.5 to 4.0 is used. An aqueous active silica solution having an SiO₂ concentration of about 1 to 10% by mass is prepared by removing the alkali metal from the aqueous alkali silicate solution diluted so as to achieve a solid content concentration of several %. The term “solid content” as used herein refers to all components of the aqueous active silica solution or the silica sol (except for the solvent (water)), and the term “solid content concentration” refers to the concentration of all components of the aqueous active silica solution or the silica sol (except for the solvent (water)). The alkali metal is removed by an ion-exchange method using a cation-exchange resin. The aqueous active silica solution prepared by dealkalization of the aqueous alkali silicate solution corresponds to an aqueous solution wherein an orthosilicate monomer and a pyrosilicate dimer (solid content: 1 to 10% by mass in total) are dissolved in water. Since an aqueous active silica solution is a very unstable aqueous solution, the active silica contained in the aqueous solution undergoes polycondensation even at room temperature and is formed into silica particles within several hours through polymerization (particle growth). Since a common aqueous active silica solution is unstable, particles are gradually grown from the active silica. This poses a problem that difficulty is encountered in handling the aqueous active silica solution for producing silica particles having a uniform particle shape. Thus, a demand has arisen for an aqueous active silica solution that remains stable for a long period of time. In particular, the production method for silica particles wherein particles are grown with a feed liquid by using seed particles as cores may encounter difficulty in producing the silica particles due to thickening of an aqueous active silica solution (i.e., feed liquid).

In the present invention, at least one stabilizer A selected from the group consisting of an acid, potassium hydroxide, ammonia, and an organic base is incorporated into an aqueous active silica solution in an amount of 0.167 to 10% by mass/SiO₂, whereby the aqueous active silica solution can be stably stored for a long period of time. For example, the aqueous active silica solution having an SiO₂ concentration of 2.8 to 3.3% by mass exhibits a viscosity of 0.5 to 20 mPa·s as measured by the Ostwald method at 23° C. within three hours after production, and the viscosity of the aqueous active silica solution measured after storage at 23° C. for three days is 5.0 times or less, preferably 3.0 times or less, for example, 0.5 to 5.0 times or 0.5 to 3.0 times the viscosity measured at 23° C. within three hours after production. Thus, the aqueous active silica solution of the present invention can remain stable. In the present application, the SiO₂ concentration of the aqueous active silica solution is not limited to 2.8 to 3.3% by mass. The present invention may involve the use of an aqueous active silica solution having an SiO₂ concentration of about 1 to 10% by mass.

The viscosity measurement by the Ostwald method is according to JIS 2283 or JIS Z8803.

Firstly, the time of flow T_{W} (s) of pure water at 25° C. is measured with a commercially available Ostwald viscometer No. 2, and a viscometer coefficient A is calculated by using the following Formula (1).

$$A = {T}_{W} \times 0.997 \div 0.8902 \qquad ( 1 )$$

In Formula (1), 0.9970 corresponds to the density of water at 25° C. (g/cm³), and 0.8902 corresponds to the viscosity of water at 25° C. (mPa·s).

Subsequently, the time of flow T_{S} (s) of each aqueous active silica solution at 25° C. is measured with the Ostwald viscometer No. 2 used for measurement of the time of flow of pure water, and the Ostwald viscosity ηs of the aqueous active silica solution is calculated by using the following Formula (2).

$${η}_{S} ( mPa \cdot s ) = {T}_{S} \times the specific gravity of the aqueous active silica solution \div A \qquad ( 2 )$$

For measurement of the specific gravity of each aqueous active silica solution, the temperature of the aqueous active silica solution is adjusted to 20° C., and the aqueous active silica solution is subjected to the hydrometer method.

The average primary particle diameter of the silica sol generally corresponds to the particle diameter determined by converting the specific surface area of silica particles measured by the nitrogen adsorption method into that of spherical particles. The average primary particle diameter D (nm) is calculated by the following formula:

$$D = 6 , 000 / ( S \times d ) wherein S is the specific surface area ( {m}^{2} / g ) , \\ and d is the true specific gravity ( g / {cm}^{3} ) .$$

The aforementioned stabilizer A is at least one compound selected from the group consisting of an acid, potassium hydroxide, ammonia, and an organic base.

Examples of the acid include an inorganic acid and an organic acid. The inorganic acid is, for example, sulfuric acid or nitric acid, and the organic acid is, for example, citric acid.

The organic base is, for example, an amine or a quaternary ammonium hydroxide. Examples of the amine include primary amines such as monomethylamine and monoethylamine; secondary amines such as dimethylamine and diethylamine; and tertiary amines such as trimethylamine and triethylamine. Examples of the quaternary ammonium hydroxide include tetramethylammonium hydroxide and tetraethylammonium hydroxide.

The silica sol production method of the present invention includes the following processes (a) and (b):
process (a): a process including a step of incorporating, into an aqueous active silica solution (a0), at least one stabilizer A selected from the group consisting of an acid, potassium hydroxide, ammonia, and an organic base so that the amount of the stabilizer A is 0.167 to 10% by mass/SiO₂, thereby preparing a stabilized aqueous active silica solution (a1), and a step of incorporating potassium hydroxide into the stabilized aqueous active silica solution (a1) or a silica sol containing silica particles having an average primary particle diameter of 5 to 90 nm so that the ratio by mole of SiO₂/K₂O is 1.5 to 20, thereby preparing the seed liquid (a2); and
process (b): a process of heating the seed liquid (a2) prepared in the process (a) at 90 to 150° C.

As described above, the aqueous active silica solution (a0) used in the present invention is prepared by removing an alkali metal from an aqueous alkali silicate solution. The aqueous active silica solution contains impurities (in an amount of several % or less) contained in the aqueous alkali silicate solution used as a raw material. The impurities are metal impurities other than alkali metals. The present invention may involve the use of an aqueous active silica solution (a0) wherein the amount of the metal impurities is reduced to 100 ppm/SiO₂ or less, or 50 ppm/SiO₂ or less. Examples of the aforementioned metal impurities include iron, aluminum, calcium, magnesium, titanium, zirconium, copper, nickel, chromium, and zinc.

The method for preparing the aqueous active silica solution (a0) wherein the amount of the metal impurities is reduced includes a process of preparing the aqueous active silica solution (a0) by dealkalization of an aqueous alkali silicate solution (process c1); a process of adding an acid (e.g., sulfuric acid) to the aqueous active silica solution (a0) for elution (leaching) of the metal impurities with the acid (process c2); and a process of subjecting the acid-added aqueous active silica solution to cation exchange and anion exchange by bringing the aqueous active silica solution into contact with, for example, a cation-exchange resin and an anion-exchange resin so as to remove the eluted metal impurities and the added acid from the active silica, thereby preparing the aqueous active silica solution (a0) (process c3).

The metal impurities may be eluted from the aqueous active silica solution with an acid by aging at a temperature of, for example, higher than 0° C. and lower than 40° C. for 1 to 30 hours.

The acid used for the aforementioned elution may be added so that the aqueous active silica solution (a0) exhibits a pH of 0.5 to 3.0 after addition of the acid in the process (c2), and the aqueous active silica solution (a0) exhibits a pH of more than 3.0 and 6.0 or less after being brought into contact with a cation-exchange resin and an anion-exchange resin after elution of the metal impurities in the process (c3). The acid used in the process (c2) is preferably sulfuric acid.

The process (a) may include a step of incorporating, into the metal-impurity-reduced aqueous active silica solution (a0), at least one stabilizer A selected from the group consisting of an acid, potassium hydroxide, ammonia, and an organic base so that the amount of the stabilizer A is 0.167 to 10% by mass/SiO₂, thereby preparing a stabilized aqueous active silica solution (a1). The silica sol of the present invention may be produced by using the stabilized aqueous active silica solution.

In this case, the aqueous active silica solution may contain the stabilizer A in an amount of 0.167 to 10% by mass/SiO₂, and thus the stabilizer A may be added so that the amount thereof is 0.167 to 10% by mass/SiO₂. When the stabilizer A and the acid used in the process (c2) for the elution (leaching) are the same acid (e.g., sulfuric acid), the amount of the stabilizer A (acid) may be determined so that the total amount of the stabilizer A (acid) and the acid (sulfuric acid) added during the preceding elution and remaining after contact of the aqueous active silica solution with the cation-exchange resin and the anion-exchange resin in the process (c3) is 0.167 to 10% by mass/SiO₂.

In the case where the acid is removed in the process (c3) by sufficient contact of the aqueous active silica solution with the cation-exchange resin and the anion-exchange resin, the acid (stabilizer A) is preferably added so that the amount thereof is 0.167 to 10% by mass/SiO₂ in the aqueous active silica solution.

The stabilizer A used for the aforementioned stabilized aqueous active silica solution (a1) is preferably sulfuric acid or potassium hydroxide. In particular, sulfuric acid is preferably used. In the case where the amount of the stabilizer A is less than 0.167% by mass/SiO₂, the stabilizer A has an insufficient effect of stabilizing the aqueous active silica solution. When sulfuric acid is used as the stabilizer A, sulfuric acid in an amount of more than 10% by mass/SiO₂ reacts with potassium hydroxide or potassium carbonate added for preparing the seed liquid (a2), and a large amount of a salt generated through the reaction in the system causes destabilization of the aqueous active silica solution, which is not preferred. In the case where potassium hydroxide is used as the stabilizer A, potassium hydroxide in an amount of more than 10% by mass/SiO₂ may inhibit growth of silica particles when the stabilized aqueous active silica solution is applied to a feed liquid.

The process (a) includes a step of adding potassium hydroxide or potassium carbonate to the stabilized aqueous active silica solution (al) so that the ratio by mole of SiO₂/K₂O is 1.5 to 20, thereby preparing a seed liquid (a2). The aforementioned potassium source is an alkaline potassium compound such as potassium hydroxide or potassium carbonate, and is preferably potassium hydroxide. When the ratio by mole of SiO₂/K₂O is 1.5 to 20 in the stabilized aqueous active silica solution, silica particles can be generated in the process (b) under heating at 90 to 150° C., and a silica sol can be produced with particle size regulation. The silica component derived from the active silica present in the liquid prepared through the process (a) serves as cores, and silica particles are gradually grown by coating of the surfaces of the cores with the silica component dissolved with potassium hydroxide. The active-silica-derived silica component serving as the cores is silica particles; i.e., a polycondensate of the active silica.

In the present invention, the seed liquid (a2) may be prepared by adding potassium hydroxide or potassium carbonate to a silica sol containing silica particles having an average primary particle diameter of 5 to 90 nm so that the ratio by mole of SiO₂/K₂O is 1.5 to 20.

The silica sol containing silica particles having an average primary particle diameter of 5 to 90 nm may be a commercially available silica sol or a silica sol prepared by any known method. For example, the silica sol used may be prepared by heating the aforementioned stabilized aqueous active silica solution (a1). Alternatively, the seed liquid (a2) may be prepared by adding potassium hydroxide or potassium carbonate to the silica sol produced by the present invention so that the ratio by mole of SiO₂/K₂O is 1.5 to 20. This procedure can produce a silica sol containing silica particles having increased particle diameter by a multistep process.

According to the silica sol production method of the present invention, a silica sol may be produced by heating the aforementioned seed liquid (a2), or a silica sol may be produced by using the seed liquid (a2) and the feed liquid (b1).

When silica particles having a large particle diameter are produced in a stepwise manner by using the seed liquid and the feed liquid in the process (b), the aqueous active silica solution prepared in the process (a) is used as the seed liquid, and the feed liquid can be added in a stepwise manner during the heating operation in the process (b).

In the silica sol production method of the present invention, the process (b) further includes a process of adding the feed liquid (b1).

The feed liquid (b1) is an aqueous active silica solution (b1) stabilized by adding at least one stabilizer B selected from the group consisting of an acid, potassium hydroxide, ammonia, and an organic base to the aqueous active silica solution (a0) so that the amount of the stabilizer B is 0.167 to 10% by mass/SiO₂.

In the relationship between the seed liquid and the feed liquid, for example, the stabilizer A and the stabilizer B are used in the following combination: the stabilizer A used for the stabilized aqueous active silica solution (a1) is sulfuric acid, and the stabilizer B used for the stabilized aqueous active silica solution (b1) is sulfuric acid.

In this case, the stabilizer A used for the stabilized aqueous active silica solution (a1) is sulfuric acid, the agent for adjusting the ratio by mole of SiO₂/K₂O in the seed liquid (a2) is potassium hydroxide, and the stabilizer B for the stabilized aqueous active silica solution (b1) used as the feed liquid is sulfuric acid.

In the relationship between the seed liquid and the feed liquid, for example, the stabilizer A and the stabilizer B are used in the following combination: the stabilizer A used for the stabilized aqueous active silica solution (a1) is potassium hydroxide, and the stabilizer B used for the stabilized aqueous active silica solution (b1) is potassium hydroxide.

In this case, the stabilizer A used for the stabilized aqueous active silica solution (a1) is potassium hydroxide, the agent for adjusting the ratio by mole of SiO₂/K₂O in the seed liquid (a2) is potassium hydroxide, and the stabilizer B for the stabilized aqueous active silica solution (b1) used as the feed liquid is potassium hydroxide.

The resultant silica sol may be subjected to cation exchange, anion exchange, or a combination thereof for reducing the amount of impurities.

The silica sol may be subjected to ultrafiltration or evaporation for adjusting the SiO₂ concentration of the silica sol. For example, the SiO₂ concentration may be adjusted to 20% by mass to 50% by mass.

The silica sol of the present invention contains silica particles; i.e., a polycondensate of the active silica contained in the aforementioned stabilized aqueous active silica solution. The silica particles serve as cores, and the surfaces of the cores are coated with a silica component dissolved with potassium hydroxide, to thereby grow silica particles. The silica sol contains the thus-grown silica particles.

The silica particles contained in the silica sol of the present invention have an average primary particle diameter of 5 to 300 nm.

The silica sol of the present invention may also contain additional components, for example, potassium ions and sodium ions.

For example, when the silica sol has an SiO₂ concentration of 20% by mass, the amount of potassium ions contained in the silica sol is 1,500 to 5,000 ppm, and the ratio of (potassium ion concentration by ppm)/(Na ion concentration by ppm) is 100 to 1,000.

### EXAMPLES

### Example 1

### Process (a)

Sodium liquid glass (JIS No. 3) was provided as a water-soluble alkali metal silicate (raw material). The liquid glass contained main components other than water; i.e., SiO₂ (28.8% by mass) and Na₂O (9.47% by mass). Firstly, 478 g of the liquid glass was dissolved in 2,992 g of pure water to thereby prepare 3,470 g of an aqueous sodium silicate solution. Subsequently, the aqueous sodium silicate solution was caused to pass through a column charged with a hydrogen-type strongly acidic cation-exchange resin Amberlite IR-120B at a space velocity of 4.5 per hour, and then 3,000 g of the resultant aqueous active silica solution (a0) was recovered in a container.

8% Aqueous sulfuric acid solution was added to the aqueous active silica solution (a0) so that the amount of sulfuric acid serving as a stabilizer was 0.313% by mass/SiO₂, to thereby prepare a stabilized aqueous active silica solution (a1). The viscosity of the aqueous active silica solution as measured by the Ostwald method was 1.0 mPa·s immediately after production, and 2.2 mPa·s after storage at 23° C. for three days.

A stainless steel (SUS)-made pressure-resistant container (inner volume: 3 L) equipped with a stirrer, a heater, etc. was used as a reactor. A seed liquid (a2) (pH=12.1) was prepared by using the stabilized aqueous active silica solution (a1, SiO₂ content: 3.2% by mass), 10% by mass aqueous potassium hydroxide solution, and pure water. The prepared seed liquid (a2) exhibited a ratio by mole of SiO₂/K₂O of 2.2.

### Process (b)

The seed liquid (a2) was added to the reactor and heated with stirring, to thereby adjust the liquid temperature in the container to 110 to 130° C. After the temperature of the container reached 100 to 130° C., while the liquid temperature in the container was maintained at 110 to 130° C., the stabilized aqueous active silica solution (a1) prepared in the process (a) (serving as a feed liquid (b1)) was continuously supplied until the pH of the reaction mixture reached 11.2.

Subsequently, while the resultant reaction mixture was maintained at 110 to 130° C., the reaction mixture was continued to be heated with stirring for two hours, to thereby produce a silica sol 1. The resultant silica sol 1was concentrated at room temperature until the SiO₂ concentration reached 40% by mass by using a commercially available ultrafiltration apparatus equipped with a polysulfone-made tubular ultrafiltration membrane having a pore size of about 5 nm. The silica sol 1 remained stable during this concentration, and the concentration proceeded very smoothly. The silica particles contained in the silica sol 1 were found to have a primary particle diameter of 44 nm as calculated by the nitrogen adsorption method.

### Example 2

A silica sol 2 was produced in the same manner as in Example 1, except that, in the process (a), 8% aqueous sulfuric acid solution was added to the aqueous active silica solution (a0) so that the amount of sulfuric acid serving as a stabilizer was 0.938% by mass/SiO₂, to thereby prepare a stable aqueous active silica solution (a1).

The viscosity of the stabilized aqueous active silica solution (al) as measured by the Ostwald method was 1.0 mPa·s immediately after production, and 1.3 mPa·s after storage at 23° C. for three days. The seed liquid (a2) exhibited a pH of 12.1, and the reaction mixture exhibited a pH of 11.1 after supply of the feed liquid in the process (b). The silica particles contained in the silica sol 2 were found to have a primary particle diameter of 43 nm as calculated by the nitrogen adsorption method.

### Example 3

A silica sol 3 was produced in the same manner as in Example 1, except that, in the process (a), 8% aqueous sulfuric acid solution was added to the aqueous active silica solution (a0) so that the amount of sulfuric acid serving as a stabilizer was 9.38% by mass/SiO₂, to thereby prepare an aqueous active silica solution (a1).

The viscosity of the stabilized aqueous active silica solution (a1) as measured by the Ostwald method was 1.0 mPa·s immediately after production, and 1.1 mPa·s after storage at 23° C. for three days. The seed liquid (a2) exhibited a pH of 12.2, and the reaction mixture exhibited a pH of 9.7 after supply of the feed liquid in the process (b). The silica particles contained in the silica sol 3 were found to have a primary particle diameter of 50 nm as calculated by the nitrogen adsorption method.

### Example 4

The procedure was performed in the same manner as in Example 1, except that, in the process (a), 10% aqueous nitric acid solution was added to the aqueous active silica solution (a0) so that the amount of nitric acid serving as a stabilizer was 0.938% by mass/SiO₂, to thereby prepare a stabilized aqueous active silica solution (a1).

The viscosity of the stabilized aqueous active silica solution (a1) as measured by the Ostwald method was 1.0 mPa·s immediately after production, and 1.2 mPa·s after storage at 23° C. for three days.

### Example 5

The procedure was performed in the same manner as in Example 1, except that, in the process (a), citric acid monohydrate was added to the aqueous active silica solution (a0) so that the amount of citric acid serving as a stabilizer was 9.38% by mass/SiO₂, to thereby prepare a stabilized aqueous active silica solution (a1).

The viscosity of the stabilized aqueous active silica solution (a1) as measured by the Ostwald method was 1.2 mPa·s immediately after production, and 2.0 mPa·s after storage at 23° C. for three days.

### Example 6

The procedure was performed in the same manner as in Example 1, except that, in the process (a), 28% aqueous ammonia solution was added to the aqueous active silica solution (a0) so that the amount of ammonia serving as a stabilizer was 0.938% by mass/SiO₂, to thereby prepare a stabilized aqueous active silica solution (a1).

The viscosity of the stabilized aqueous active silica solution (a1) as measured by the Ostwald method was 1.6 mPa·s immediately after production, and 1.4 mPa·s after storage at 23° C. for three days.

### Example 7

A silica sol 7 was produced in the same manner as in Example 1, except that, in the process (a), N,N-diethylmethylamine was added to the aqueous active silica solution (a0) so that the amount of N,N-diethylmethylamine serving as a stabilizer was 9.38% by mass/SiO₂, to thereby prepare a stabilized aqueous active silica solution (a1).

The viscosity of the stabilized aqueous active silica solution (a1) as measured by the Ostwald method was 2.9 mPa·s immediately after production, and 2.5 mPa·s after storage at 23° C. for three days.

### Example 8

A silica sol 8 was produced in the same manner as in Example 1, except that, in the process (a), 10% aqueous potassium hydroxide solution was added to the aqueous active silica solution (a0) so that the amount of potassium hydroxide (in terms of potassium oxide) serving as a stabilizer was 0.938% by mass/SiO₂, to thereby prepare a stabilized aqueous active silica solution (a1).

The viscosity of the stabilized aqueous active silica solution (a1) as measured by the Ostwald method was 11.0 mPa·s immediately after production, and 13.3 mPa·s after storage at 23° C. for three days.

### Comparative Example 1

An aqueous active silica solution (a0) was synthesized in the same manner as in Example 1. The aqueous active silica solution (a0) containing no stabilizer gelled the next day.

### Comparative Example 2

The procedure was performed in the same manner as in Example 1, except that, in the process (a), 8% aqueous sulfuric acid solution was added to the aqueous active silica solution (a0) so that the amount of sulfuric acid serving as a stabilizer was 0.156% by mass/SiO₂, to thereby prepare an aqueous active silica solution containing sulfuric acid serving as a stabilizer.

The viscosity of the aqueous active silica solution containing sulfuric acid serving as a stabilizer as measured by the Ostwald method was 1.0 mPa·s immediately after production. However, the aqueous active silica solution gelled after storage at 23° C. for three days.

### Comparative Example 3

The procedure was performed in the same manner as in Example 1, except that, in the process (a), 8% aqueous sulfuric acid solution was added to the aqueous active silica solution (a0) so that the amount of sulfuric acid serving as a stabilizer was 18.8% by mass/SiO₂, to thereby prepare an aqueous active silica solution containing sulfuric acid serving as a stabilizer.

The viscosity of the aqueous active silica solution containing sulfuric acid serving as a stabilizer as measured by the Ostwald method was 1.0 mPa·s immediately after production, and 1.0 mPa·s after storage at 23° C. for three days. The pH of the seed liquid (a2) was adjusted to 10.4, and the ratio by mole of SiO₂/K₂O was 1.2 after the pH adjustment. However, a large amount of gel was generated after supply of the feed liquid in the process (b), resulting in failure to produce a silica sol.

### Comparative Example 4

The procedure was performed in the same manner as in Example 1, except that, in the process (a), 8% aqueous sulfuric acid solution was added to the aqueous active silica solution (a0) so that the amount of sulfuric acid serving as a stabilizer was 31.3% by mass/SiO₂, to thereby prepare an aqueous active silica solution containing sulfuric acid serving as a stabilizer.

The viscosity of the aqueous active silica solution containing sulfuric acid serving as a stabilizer as measured by the Ostwald method was 1.0 mPa·s immediately after production, and 1.0 mPa·s after storage at 23° C. for three days. The pH of the seed liquid was adjusted to 10.4, and the ratio by mole of SiO₂/K₂O was 0.7 after the pH adjustment. However, a large amount of gel was generated after supply of the feed liquid in the process (b), resulting in failure to produce a silica sol.

### INDUSTRIAL APPLICABILITY

The present invention provides a stabilized aqueous active silica solution prepared by stabilization of an unstable aqueous active silica solution. The use of the active silica can produce a silica sol having controlled particle diameter distribution and particle shape.

1. A stabilized aqueous active silica solution comprising at least one stabilizer A selected from the group consisting of an acid, potassium hydroxide, ammonia, and an organic base, wherein
the amount of the stabilizer A is 0.167 to 10% by mass relative to the mass of SiO₂ contained in the aqueous active silica solution.

2. The stabilized aqueous active silica solution according to claim 1, wherein the acid is an inorganic acid or an organic acid.

3. The stabilized aqueous active silica solution according to claim 2, wherein the inorganic acid is sulfuric acid or nitric acid.

4. The stabilized aqueous active silica solution according to claim 2, wherein the organic acid is citric acid.

5. The stabilized aqueous active silica solution according to claim 1, wherein the organic base is an amine or a quaternary ammonium hydroxide.

6. The stabilized aqueous active silica solution according to any one of claims 1 to 5, wherein the aqueous active silica solution having an SiO₂ concentration of 2.8 to 3.3% by mass exhibits a viscosity of 0.5 to 20 mPa·s as measured by the Ostwald method at 23° C. within three hours after production, and the viscosity of the aqueous active silica solution measured after storage at 23° C. for three days is 5.0 times or less the viscosity measured at 23° C. within three hours after production.

7. A silica sol comprising silica particles that are a polycondensate of the active silica contained in the stabilized aqueous active silica solution according to any one of claims 1 to 6, wherein the silica particles have an average primary particle diameter of 5 to 300 nm.

8. The silica sol according to claim 7, wherein the silica sol contains potassium ions and sodium ions, and, when the silica sol has an SiO₂ concentration of 20% by mass, the amount of potassium ions contained in the silica sol is 1,500 to 5,000 ppm, and the ratio of (potassium ion concentration by ppm)/(Na ion concentration by ppm) is 100 to 1,000.

9. A production method for the silica sol according to claim 7 or 8, the production method comprising the following processes (a) and (b):
process (a): a process including a step of incorporating, into an aqueous active silica solution (a0), at least one stabilizer A selected from the group consisting of an acid, potassium hydroxide, ammonia, and an organic base so that the amount of the stabilizer A is 0.167 to 10% by mass/SiO₂, thereby preparing a stabilized aqueous active silica solution (a1), and a step of incorporating potassium hydroxide into the stabilized aqueous active silica solution (a1) or a silica sol containing silica particles having an average primary particle diameter of 5 to 90 nm so that the ratio by mole of SiO₂/K₂O is 1.5 to 20, thereby preparing the seed liquid (a2); and
process (b): a process of heating the seed liquid (a2) prepared in the process (a) at 90 to 150° C.

10. The production method for the silica sol according to claim 9, wherein the aqueous active silica solution (a0) used in the process (a) is prepared through:
a process (c1) of preparing an aqueous active silica solution by cation exchange of liquid glass,
a process (c2) of adding an acid to the aqueous active silica solution, and aging the aqueous active silica solution at a temperature of higher than 0° C. and lower than 40° C. for 1 to 30 hours, and
a process (c3) of subjecting the aged aqueous active silica solution to cation exchange and anion exchange, thereby preparing the aqueous active silica solution (a0).

11. The production method for the silica sol according to claim 10, wherein, in the process (c2), the aqueous active silica solution exhibits a pH of 0.5 to 3.0 after addition of the acid, and the aqueous active silica solution (a0) prepared through the process (c3) exhibits a pH of more than 3.0 and 6.0 or less.

12. The production method for the silica sol according to claim 10 or 11, wherein the acid used in the process (c2) is sulfuric acid.

13. The production method for the silica sol according to any one of claims 9 to 12, wherein the process (b) further includes a process of adding, to the heated seed liquid (a2), a feed liquid (b1) stabilized by adding at least one stabilizer B selected from the group consisting of an acid, potassium hydroxide, ammonia, and an organic base to the aqueous active silica solution (a0) so that the amount of the stabilizer B is 0.167 to 10% by mass relative to the mass of SiO₂ contained in the aqueous active silica solution.

14. The production method according to claim 13, wherein the stabilizer A is sulfuric acid, the agent for adjusting the ratio by mole of SiO₂/K₂O is potassium hydroxide, and the stabilizer B is sulfuric acid.

15. The production method according to claim 13, wherein the stabilizer A is potassium hydroxide, the agent for adjusting the ratio by mole of SiO₂/K₂O is potassium hydroxide, and the stabilizer B is potassium hydroxide.
